(19) United States
(12) Patent Application Publication
(10) Pub. No.: US 2010/0115877 A1
(43) Pub. Date: May 13, 2010

(54) SASH FOR WINDOWS AND DOORS WITH ATTACHABLE AND DETACHABLE RAILS

(76) Inventors: Jung Sik Yoo, Incheon (KR); Joo Han Kim, Incheon (KR)

Correspondence Address: CHRISTOPHER PAUL MITCHELL, 888 16TH ST., NW, SUITE 800, WASHINGTON, DC, 20006, US

(21) Appl. No.: 12/593,918

(22) PCT Filed: Mar. 28, 2008
(86) PCT No.: PCT/KR08/01760

§ 371 Date: Sep. 29, 2009

(30) Foreign Application Priority Data
Mar. 30, 2007 (KR) 10-2007-0031299

(51) Int. Cl. E06B 3/32; E06B 3/667

(52) U.S. Cl. 52/656.2

(57) ABSTRACT

There is provided a window and door frame for doors and windows built in a wall of a building. The window and door frame includes an extruded frame member. One face of the frame member is formed along a length direction thereof with a rail insertion groove. The window and door frame further includes a rail structure adapted to be combined with the rail insertion groove. The rail insertion groove is formed with engagement grooves, while the rail structure is formed with engagement projections. The rail structure is easily combined to and removed from the frame member by means of engagement between the engagement projections and the engagement grooves. Since the rail structure is attachable and detachable, a heavier door can be conveniently installed and the window and door frame can be easily cleaned up. Further, only a damaged rail structure can be replaced.

### TECHNICAL FIELD

The present invention generally relates to a window and door frame for doors or windows built in a wall of a building, and more particularly to a window and door frame including a frame member formed along a length direction thereof with an insertion groove, wherein a rail structure can be attached to and detached from the insertion groove.

### BACKGROUND ART

Various windows and doors are typically built in apartment houses, detached houses, office buildings, schools, public institution buildings, etc. for purposes of lighting, ventilation, entrance/exit and space partitioning.

Such windows and doors are diversely sized from a small-sized window and door to be used as a window to a large-sized window and door to be built throughout an entire wall. For example, there is a window and door in which one or two doors are installed by using a window and door frame having a one-row rail portion. Also, there is a sliding window and door wherein three or four doors are installed by using a window and door frame having four-row rail portions.

Window and door frames, on which a door is placed and configured to slide, are made from diverse materials. Window and door frames made from wood were used in the past. However, recently, extruded window and door frames of metallic material or synthetic resin material have been primarily used due to durability.

Such window and door frames include rail portions for smooth movement of the door, as is generally known. The rail portions of the recently widely used window and door frames of metallic material or synthetic resin material are integrally formed in the window and door frames when extruding the window and door frames. That is, extrusion molds for forming the window and door frames are configured such that the rail portions are formed together with the window and door frames. Thus, the window and door frames of metallic material or synthetic resin material are formed with a one-row or double-row rail portion projecting therefrom. Such a rail portion permits smooth sliding of the door.

Such a prior art window and door frame and a door are shown in FIG. 1. Referring to FIG. 1, inside a rectangular frame-shaped window and door frame 11 with a plurality of rail portions 11a, 11a′ protruding thereon, doors 40, 40′ are located as joined to the rail portions 11a, 11a′. Rollers 41, which roll along the rail portions 11a, 11a′ are built in a lower side of a frame of the door 40, 40′. Since the rollers 31 roll along the rail portions 11a, 11a′ when the doors 40, 40′ are opened or closed, the door 40, 40′ can be opened and closed with ease. Further, the window and door frame 11 and lateral sides of a bottom edge of the frame of the doors 40, 40′ are formed with perpendicular blocking portions. This is so that indoor air and outdoor air isolated by the window and door are restricted from communicating with each other, while enhancing thermal insulation and soundproofing.

When constructing such a window and door, as shown in FIG. 2, the rectangular-shaped window and door frame 11 is first installed. A top edge of the door 40 is then fitted into a top side of the window and door frame 11 and a bottom edge of the door 40 is placed on a bottom side of the window and door frame, thereby completing the window and door. Due to such an installation method, a rail groove formed at the top edge of the door is deeper than a rail groove formed at the bottom edge of the door.

The above-described window and door is constructed in a manner such that the door is lifted up and the top edge of the door is first inserted into the top side of the window and door frame and the bottom edge of the door is put on the bottom side of the window and door frame. As the door lifted upwardly is put on the bottom side of the window and door frame, a substantial space is formed between the top edge of the door and the top side of the window and door frame. This causes a problem in that external air is permitted to freely flow through said substantial space. Accordingly, since the external air freely flows through a gap between the top edge of the door and the top side of the window and door frame, soundproof and thermal insulation effects are greatly lowered.

In order to solve the aforementioned problem, recent windows and doors are configured such that a fine bristle brush is inserted in a lateral edge of the door or into a lateral side of the window and door frame along a length direction thereof. The fine bristle brush may enhance soundproof and thermal insulation effects. However, such enhancement cannot reach a sufficiently satisfactory degree. Further, material cost and installation cost are doubled. In addition, smooth sliding of the door during opening and closing of the door is not accomplished due to friction between the brush and the door or between the brush and the window and door frame.

Further, a top edge of a door is first fitted into a top side of a window and door frame and a bottom edge of a door is then put on a bottom side of a window and door frame when conventional windows and doors are installed. Accordingly, when a large-sized window and door is constructed, since at least two or more workers must lift a heavier door up and install it, installation work becomes very difficult.

Moreover, in the windows and doors installed in the above-described manner, inner sections of the window and door frame are gradually contaminated by various foreign substances as time elapses. In the above-described window and door frame with the rail portions and the blocking portions, cleaning becomes uneasy due to a very narrow gap between the rail portions. Thus, since the window and door frame remains contaminated by foreign substances such as dust, soil and the like, the window and door frame does not have a good appearance and is very unclean in terms of sanitation. However, since there are no suitable cleaning tools and cleaning methods, such window and door frames are often left as they are.

Also, a conventional window and door is composed of a window and door frame and a door and a rail for guiding sliding of a door are protrudingly formed on the window and door frame in advance as fixed thereto. Thus, when the door is fitted, substantial gaps are inevitably formed between the window and door frame and the top and bottom edges of the door. Such gaps weaken the window and door in the event of strong wind, thunder, earthquake, etc. There is a problem in that when vibration or pressure caused by strong wind, thunder, earthquake, etc. is applied to the window and door, the door can be separated from the window and door frame and then fall to the ground. As such, safety accidents can occur.

In particular, the above-described window and door causes a feeling of uneasiness since the window or the door is shaken or rattled by wind. Further, outdoor air, which flows into the interior of a room through said gaps without any filtration, may result in a respiratory disease since it may contain foreign substances such as minute dusts.

### DISCLOSURE OF INVENTION

### Technical Problem

The present invention is directed to solving the foregoing problems. It is an object of the present invention to provide a window and door frame, which is configured such that a door can be conveniently installed and a door frame and the window and door frame are closely fitted to each other. Further, the present invention seeks to provide a window and door frame, which can be conveniently cleaned.

### Technical Solution

A window and door frame of the present invention, comprises: an upper frame member having an opposed face opposed to a top edge portion of a door frame and being extruded along a length direction thereof; and a lower frame member having an opposed face opposed to a bottom edge portion of the door frame and being extruded along a length direction thereof. The opposed faces of the upper and lower frame members are formed with rail insertion grooves. The window and door frame further comprises a rail structure having an insertion portion corresponding to the rail insertion groove. The insertion portion of the rail structure is configured to be inserted into and engaged to the rail insertion groove, wherein the rail structure can be combined with and separated from the frame member. A distance between the opposed face of the upper frame member and the opposed face of the lower frame member is equal to or greater than a height between the top edge portion and the bottom edge portion of the door frame. This is so that the door frame is installed between the opposed face of the upper frame member and the opposed face of the lower frame member in a manner such that the door frame is pushed into therebetween in an upright state relative to the ground (not in a slanted stated relative to the ground). The door frame and a roller located at the bottom edge portion thereof are placed on an upper surface of the rail structure disposed on the lower frame member so as to be movable therealong. The rail structure comprises a plurality of rail structures shorter than an overall length of the frame member.

The insertion portion of the rail structure may be formed to have a narrower width. Both lateral sides of the door frame may be formed with guide portions bent toward the insertion portion. The guide portions prevent the door frame from being removed away while enhancing soundproof and thermal insulation effects.

The insertion portion of the rail structure may be formed along a length direction thereof with an elastic groove portion. Both lateral sides of the insertion portion may be elastically deformable toward the elastic groove portion by the elastic groove portion. Thus, the insertion portion may be inserted into and engaged to the rail insertion groove.

A top surface of the rail structure may be formed with a rail projection. Further, the roller of the door frame may be shaped so as to correspond to the rail projection and be slidable thereon.

A top surface of the rail structure may be formed with a concave groove. The roller of the door frame may be shaped so as to correspond to the concave groove and be slidable thereon.

The rail insertion grooves of the frame member may be arranged in two rows. In such a case, the window and door frame may be configured to be used as a window and door frame for a single window by combining the rail structures to the two-row arranged rail insertion grooves.

The rail insertion grooves of the frame member may be arranged in four rows. In such a case, the window and door frame may be configured to be used as a window and door frame for a dual window by joining the rail structures to the four-row arranged rail insertion grooves.

Both lateral surfaces of the rail insertion groove may be formed along a length direction thereof with engagement grooves. Further, both lateral surfaces of the insertion portion of the rail structure may be formed along a length direction thereof with engagement projections. A firm engagement of the rail structure is accomplished by a mutual engagement force between the engagement projections of the rail structure and the engagement grooves of the rail insertion groove.

### ADVANTAGEOUS EFFECTS

The window and door frame of the present invention is configured such that rail portions are attachable thereto and detachable therefrom. Thus, a heavier door can be installed more conveniently. Further, when a rail portion is damaged due to an unexpected impact or accident, only such a rail portion can be replaced. Also, unnecessary gaps do not exist and a gap between a door and the window and door frame is very small, thereby providing superior soundproof and thermal insulation effects. Moreover, any other resistance element is not introduced to movement of the door, thereby allowing the door to be opened and closed more smoothly and softly. Additionally, the door can be conveniently separated by removing only the rail portion and the window and door frame that is exposed flat by doing so can also be conveniently cleaned. Thus, it is efficient in terms of maintaining cleanness in appearance and sanitation.

### BRIEF DESCRIPTION OF THE DRAWINGS

FIG. 1 is a partial perspective view of a prior art window and door.

FIG. 2 shows an installation process of a door in the prior art window and door.

FIG. 3 is a partially cutaway perspective view of a window and door frame according to the present invention.

FIG. 4 is a partially enlarged perspective view of a lower frame member and a rail structure.

FIG. 5 is a sectional view showing a combination of the window and door frame and the rail structure.

FIG. 6 is a partially enlarged perspective view of an upper frame member and the rail structure.

FIG. 7 is a sectional view showing a combination of the window and door frame of the present invention and the door.

FIG. 8 is a partial perspective view showing that the rail structure is combined with one side of the frame member.

FIG. 9 is a partial perspective view showing that the door is installed by means of the rail structures located in one side.

FIG. 10 is a partial perspective view showing that other rail structures are combined.

FIG. 11 is a sectional view showing that the window and door frame and the door are installed, and further showing the rail structure provided with a rail projection.

FIG. 12 is a sectional view showing that the window and door frame and the door are installed, and further showing the rail structure provided with a concave groove.

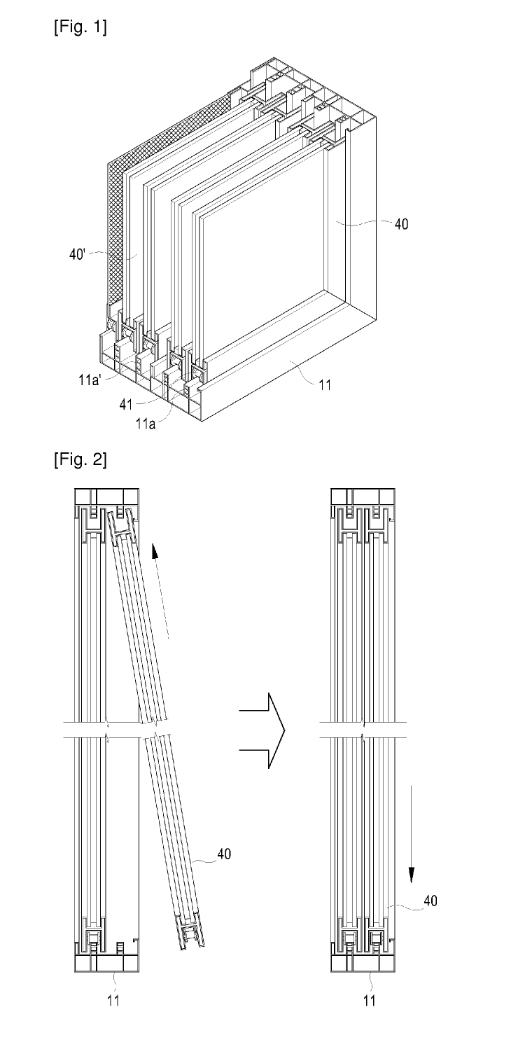

### MODE FOR THE INVENTION

A window and door frame of the present invention will now be described with reference to the accompanying drawings.

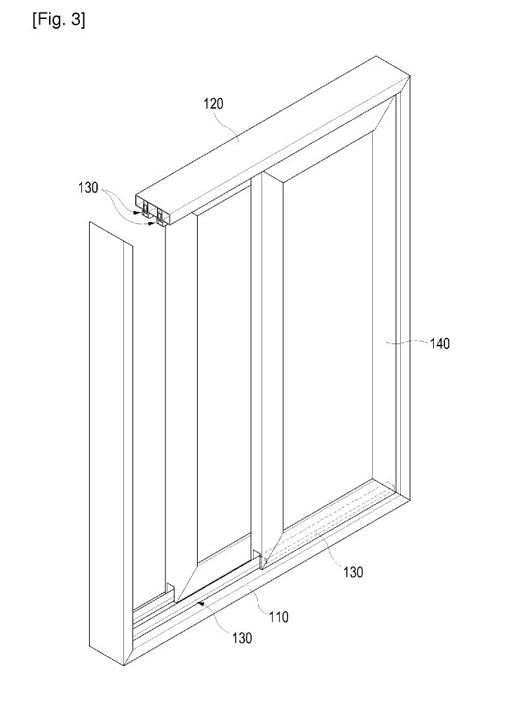

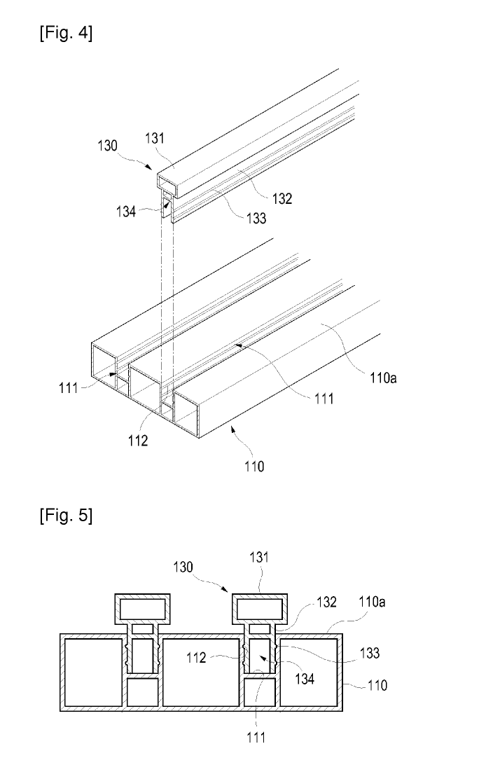

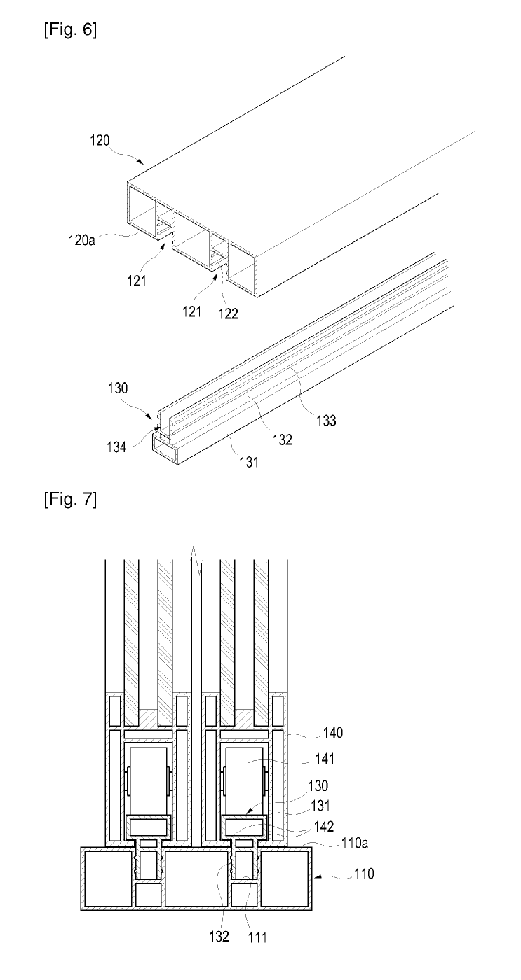

FIG. 3 is a partially cutaway perspective view of a window and door frame according to the present invention. FIG. 4 is a partially enlarged perspective view of a lower frame member and a rail structure. FIG. 5 is a sectional view showing a combination of the window and door frame and the rail structure. FIG. 6 is a partially enlarged perspective view of an upper frame member and the rail structure. FIG. 7 is a sectional view showing a combination of the window and door frame and the door.

The window and door frame of the present invention, comprises: an upper frame member 120 extruded along a length direction thereof and having an opposed face 120a opposed to a top edge portion of a door frame 140; and a lower frame member 120 extruded along a length direction thereof and having an opposed face 110a opposed to a bottom edge portion of a door frame 140. The opposed faces 120a, 110a of the upper and lower frame members 120, 110 are formed along a length direction thereof with rail insertion grooves 111, 121, respectively. The window and door frame further comprises a plurality of rail structures 130, each of which has an insertion portion 132 corresponding to the rail insertion groove 111, 121. The rail structures 130 are combined with and separated from the frame members 110, 120 in a manner such that the insertion portion 132 of the rail structure 130 is inserted into and engaged to the rail insertion grooves 111, 121 of the frame members 110, 120. A distance between the opposed face 120a of the upper frame member 120 and the opposed face 110a of the lower frame member 110 is equal to or greater than a height between the top edge portion and the bottom edge portion of the door frame 140. This is so that the door frame 140 is installed between the opposed face 120a of the upper frame member 120 and the opposed face 110a of the lower frame member 110 in a manner such that the door frame 140 is pushed into therebetween in an upright state relative to the ground, not in a slanted stated relative to the ground. The door frame 140 and a roller 141 located at the bottom edge portion thereof are placed on an upper surface of the rail structure 130 disposed on the lower frame member 110 and slide therealong. The rail structure 130 comprises a plurality of rail structures 130 shorter than an overall length of the frame members 110, 120.

Both inner lateral surfaces of the rail insertion groove 111, 121 are formed along a length direction thereof with engagement grooves 112, 122, while both lateral surfaces of the insertion portion 132 of the rail structure 130 are formed along a length direction thereof with engagement projections 133. A firm engagement of the rail structure 130 is accomplished by a mutual engagement force between the engagement projections 133 of the rail structure 130 and the engagement grooves 112, 122 of the rail insertion grooves 111, 121.

The insertion portion 132 of the rail structure 130 is formed to have a width narrower than that of a rail portion 131 of the rail structure 130. Both lateral sides of the bottom edge of the door frame 140 are formed with guide portions 142, which are bent toward the insertion portion 132. The guide portions 142 of the door frame 140 prevent the door frame 140 from being removed away, while enhancing soundproof and thermal insulation effects.

The insertion portion 132 of the rail structure 130 is formed along a length direction thereof with an elastic groove portion 134. Since both lateral sides of the insertion portion 132 are elastically deformable toward the elastic groove portion 134 by the elastic groove portion 134, the insertion portion 132 is more elastically inserted into and engaged to the rail insertion groove 111, 121.

Further, a top surface of the rail structure 130 is formed with a rail projection 135 protruding upwardly and a roller 141 shaped to correspond thereto is slidable thereon. Alternatively, a top surface of the rail structure 130 is formed with a concave groove 136 and a roller 141 shaped to correspond thereto is slidable thereon. Thus, linear movability can be enhanced during opening and closing of the door.

Also, the window and door frame of the present invention can be used as a window and door frame for a single window by arranging the rail insertion grooves 111, 121 of the frame members 110, 120 in two rows and combining the corresponding rail structures 130 to the two-row arranged rail insertion grooves 111, 121, respectively. Further, the window and door frame of the present invention can be used as a window and door frame for a dual window by arranging the rail insertion grooves 111, 121 of the frame members 110, 120 in four rows and combining the corresponding rail structures 130 to the four-row arranged rail insertion grooves 111, 121, respectively.

The window and door frame with attachable and detachable rails of the present invention, which is configured as described above, will now be described in detail with reference to FIGS. 3 to 7.

As shown, the window and door frame of the present invention comprises the extruded frame members 110, 120 and the separately formed rail structures 130. A bottom surface (opposed face) 120a of the upper frame member 120 and a top surface (opposed face) 110a of the lower frame member 110 are formed with two-row or four-row arranged rail insertion grooves 111, 121, respectively, according to a single window or a dual window. Both lateral sides of each rail insertion groove 111, 121 are formed in a length direction thereof with the engagement grooves 112, 122.

The rail structure 130 is formed with the insertion portion 132 that has a width narrower than that of the rail portion 131 and extends from the rail portion 131. Both outer lateral surfaces of the insertion portion 132 are formed along a length direction thereof with the engagement projections 133. The insertion portion 132 is adapted to be closely inserted into the rail insertion groove 111, 121 of the frame member 110, 120. The engagement projections 133 are brought into engagement with the engagement grooves 112, 122 of the rail insertion groove 111, 121.

As described above, the rail structure is constructed to be attachable to and detachable from the frame member 110, 120. A door is installed to the window and door frame when the rail structure 130 is combined with the rail insertion groove 111, 121 of the frame member 110, 120.

The top and bottom edge portions of the door frame 140 (i.e., a frame of the door) are formed along a length direction thereof with the rail grooves 143, into which the rail structure 130 is inserted, respectively. The lower side of the door frame 140 is provided with the roller 141 adapted to roll along the rail structure 130. Further, the bottom edge of the door frame 140 is formed with the guide portions 142 bent inwardly. The guide portions 142 are allowed to be located in concave portions, which are formed at lateral sides of the insertion portion 132 between the rail portion 131 and the top surface (opposed face) 110a of the lower frame member due to the narrower insertion portion 132. Thus, the guide portions 142 of the door frame 140, the shape of the rail structure 130 and their combination provide superior soundproof and thermal insulation effects. In addition, since the guide portions 142 and the rail structure 130 make a bent passage that blocks free flow of indoor air and outdoor air, there is no need to additionally attach a fine bristle brush according to the prior art. Further, such guide portions may be provided at the top edge of the door frame 140.

A prior art window and door is comprised of two parts, i.e., a window and door frame and a door. However, a window and door according to the present invention is comprised of three parts, i.e., a window and door frame, a rail structure and a door. When those three parts are assembled, the window and door frame, the rail structure and the door are closely engaged to one another, thus forming one body. Since the window and door frame, the rail structure and the door frame make one member with the above-described assembly and installation structure, gaps hardly exist between the window and door frame and the top and bottom edges of the door frame. Thus, in the case of impact or pressure caused by strong wind, thunder, earthquake, etc, there is no danger in which a door or window becomes separated from the window and door frame and then drops to the ground.

In particular, the insertion portion 132 of the rail structure 130 is formed with the elastic groove portion 134 for providing elasticity to the insertion portion 132. The elastic groove portion 134 is successively formed along a length direction of the rail structure 130. Thus, the insertion portion 132 is allowed to be elastically deformable inwardly of the elastic groove portion 134. Accordingly, the insertion portion 132 can be elastically inserted into and thus engaged to the rail insertion groove 111, 121.

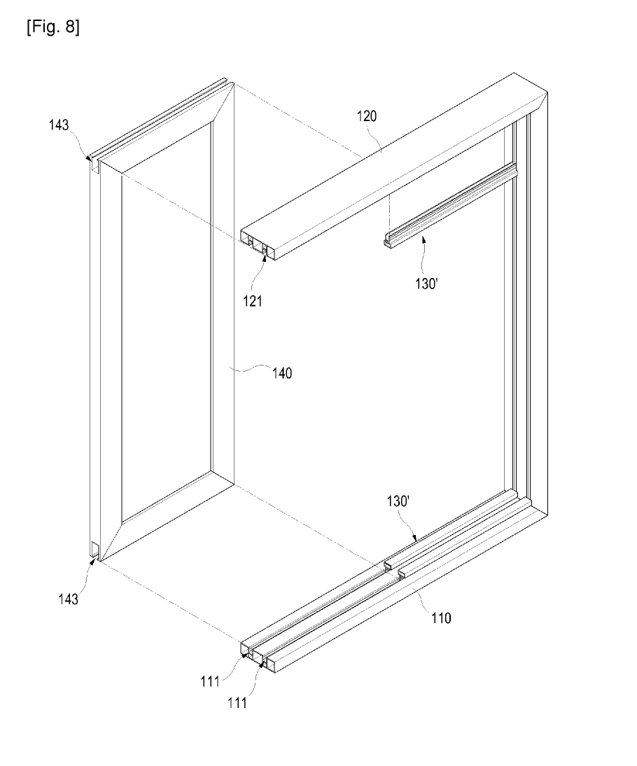

An installation process of the door frame 140 using the above-described frame members 110 and 120 and rail structure 130 will now be described with reference to FIGS. 8 to 10.

As shown in FIG. 8, the window and door frame is first installed at a place where a window and door must be constructed. Thereafter, the rail structure is combined with the frame member 110, 120. In such a case, rail structures 130′, which are shorter than half of an overall length of the frame member 110, 120, are inserted into and engaged to the rail insertion groove 111, 121 as biased to one side.

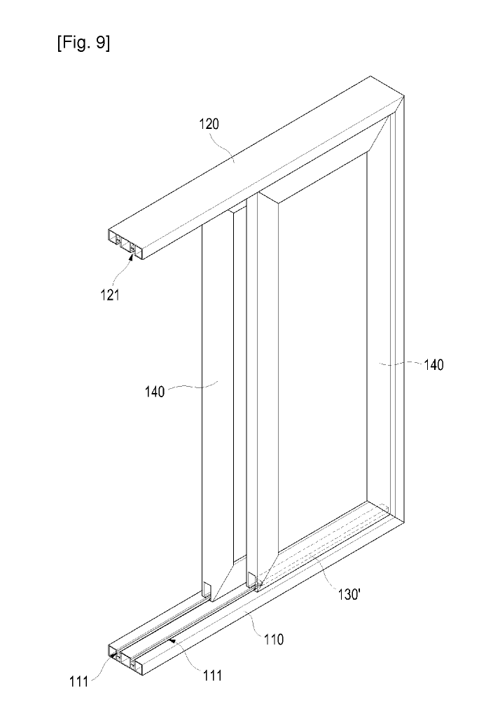

In such a state, the door frame 140 is pushed into the window and door frame through portions of the frame members 110 and 120, at which the rail structures are not inserted. Subsequently, the door frame 140 is slid toward the rail structures 130′ located at said one side. Then, as shown in FIG. 9, as the top and bottom edges of the door frame 140 are coupled to the rail structures 130′ of the frame members 110 and 120, respectively, the door frame 140 is installed to the frame members 110 and 120 with supporting forces of the rail structures 130′.

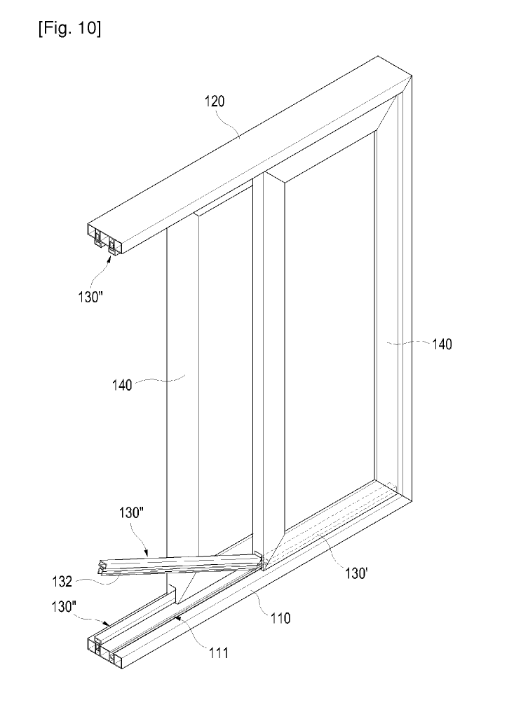

Thereafter, as shown in FIG. 10, when the door frame 140 of one side is installed, rail structures 130″, which have a length corresponding to an exposed length of the rail insertion groove 111, 121, are combined with the rail insertion groove 111, 121, thereby forming a rail portion corresponding to the overall length of the frame member 110, 120. That is, as shown in FIG. 10, the rail structures 130″, which are longer than the half of the overall length of the frame member 110, 120, are combined with the rail insertion grooves 111 and 121.

When the rail structures 130′ shorter than the half length of the frame member 110, 120 are first combined, the portions of the rail insertion grooves 111 and 121, at which the rail structures 130′ are not inserted, are longer than the half length of the frame members 110 and 120. Thus, it is possible to insert the door frame 140 corresponding to the half length of the frame members and to couple it to the previously-combined rail structures 130′. Also, the rail structures 130″ having a length corresponding to the other portions, at which the rail structures 130″ are not combined, are fitted into the rail insertion grooves 111 and 121. In such a case, although an overall length of the rail structure 130″ is longer than that of the door frame 140, it can be combined with the rail insertion groove 111, 121 by pushing one end of the rail structure 130″ into the rail insertion groove 111, 121, a portion of which is exposed at the bottom edge of the door frame 140.

If the door frame 140 is installed as described above, then gaps between the door frame 140 and the frame members 110 and 120 and the rail structures 130′ and 130″are exceedingly minimized at an upper side as well as at a lower side. Thus, superior soundproof and thermal insulation effects are obtained. Further, in case rail portions are damaged, only a damaged rail structure 130′, 130″ can be removed for replacement.

The prior art window and door frame has a difficulty in cleaning due to very narrow gap between its rail portions. However, in the window and door frame of the present invention, the rail structures 130′, 130″ can be removed from and then recombined with the window and door frame. That is, when the frame members 110 and 120 need to be cleaned up, removing the rail structures 130′, 130″ allows the bottom surface of the frame member 110 or the top surface of the frame member 120 to be exposed flat. Thus, more convenient cleaning can be done and sanitation and external cleanness can be maintained.

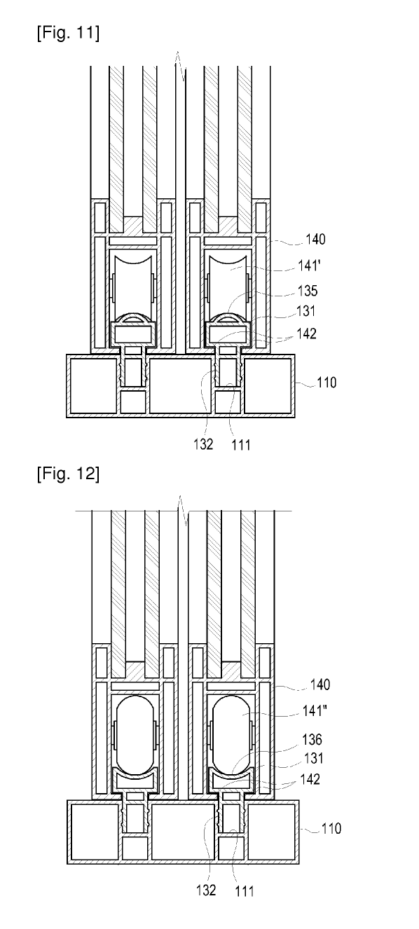

Further, the window and door frame of the present invention can provide still better linear movability of the door by forming the top surface of the rail structure with the projection or the groove and by using the roller 141′, 141″ corresponding thereto. As shown in FIG. 11, the top surface of the rail portion 131 of the rail structure 130 is formed in a length direction thereof with the rail projection 135 projecting therefrom and the roller 141′ placed in the door frame 140 is groove-shaped so as to correspond thereto, thereby providing more stable linear movability during opening and closing of the door. Further, as shown in FIG. 12, the top surface of the rail portion 131 of the rail structure 130 is formed in the length direction thereof with the concave groove 136 and the roller 141″, which is shaped so as to correspond thereto, is used, thereby providing more stable linear movability during opening and closing of the door.

Further, with regard to forming the rail insertion grooves 111 and 121 on the frame members 110 and 120, when two-row arranged rail insertion grooves 111, 121 are formed, the window and door frame of the present invention may be used for a single window. Also, when four-row arranged rail insertion grooves 111, 121 are formed, the window and door frame of the present invention may be used for a dual window. As such, the window and door frame of the present invention may be embodied in various manners according to the number of the rail insertion grooves 111, 121.

Also, in the window and door frame of the present invention, an auxiliary rail for mounting an anti-insect net thereto may be combined with the upper edge of the frame member 110, 120. Various ornamental panels may also be combined thereto.

The above-described embodiments and the attached drawings should not be construed as limiting the scope of the present invention. departing from the scope of the present invention.

### INDUSTRIAL APPLICABILITY

The present invention provides a window and door frame configured such that rail portions can be attached thereto and detached therefrom.

1. A window and door frame, comprising:
an upper frame member having an opposed face opposed to a top edge portion of a door frame and being extruded along a length direction thereof; and
a lower frame member having an opposed face opposed to a bottom edge portion of the door frame and being extruded along a length direction thereof,
wherein the opposed faces of the upper and lower frame members are formed with rail insertion grooves,
the window and door frame further comprising a rail structure having an insertion portion corresponding to the rail insertion groove,
wherein the insertion portion of the rail structure is configured to be inserted into and engaged to the rail insertion groove, whereby the rail structure is combined to and separated from the frame member,
wherein a distance between the opposed face of the upper frame member and the opposed face of the lower frame member is equal to or greater than a height between the top edge portion and the bottom edge portion of the door frame so that the door frame is installed between the opposed face of the upper frame member and the opposed face of the lower frame member in a manner that the door frame is pushed into therebetween in an upright state relative to the ground, not in a slanted stated relative to the ground,
wherein the door frame and a roller located at the bottom edge portion thereof is placed on an upper surface of the rail structure disposed on the lower frame member to be movable therealong, and
wherein the rail structure comprises a plurality of rail structures shorter than an overall length of the frame member.

2. The window and door frame of claim 1, wherein the insertion portion of the rail structure is formed to have a narrower width,
wherein both lateral sides of the door frame are formed with guide portions bent toward the insertion portion, and
wherein the guide portions prevent the door frame from being removed away while enhancing soundproof and thermal insulation effects.

3. The window and door frame of claim 1, wherein the insertion portion of the rail structure is formed along a length direction thereof with an elastic groove portion, and
wherein both lateral sides of the insertion portion are elastically deformable toward the elastic groove portion by the elastic groove portion and the insertion portion is inserted into and engaged to the rail insertion groove.

4. The window and door frame of claim 1, wherein a top surface of the rail structure is formed with a rail projection, and
wherein the roller of the door frame is shaped to correspond to the rail projection and is slidable thereon.

5. The window and door frame of claim 1, wherein a top surface of the rail structure is formed with a concave groove, and
wherein the roller of the door frame is shaped to correspond to the concave groove and is slidable thereon.

6. The window and door frame of claim 1, wherein the rail insertion grooves of the frame member are arranged in two rows, and
wherein the window and door frame is configured to be used as a window and door frame for a single window by combining the rail structures to the two-row arranged rail insertion grooves.

7. The window and door frame of claim 1, wherein the rail insertion grooves of the frame member are arranged in four rows, and
wherein the window and door frame is configured to be used as a window and door frame for a dual window by combining the rail structures to the four-row arranged rail insertion grooves.

8. The window and door frame of claim 1, wherein both lateral surfaces of the rail insertion groove are formed along a length direction thereof with engagement grooves,
wherein both lateral surfaces of the insertion portion of the rail structure are formed along a length direction thereof with engagement projections, and wherein a firm engagement of the rail structure is accomplished by a mutual engagement force between the engagement projections of the rail structure and the engagement grooves of the rail insertion groove.
